(19) United States
(12) Patent Application Publication
(10) Pub. No.: US 2002/0000540 A1
(43) Pub. Date: Jan. 3, 2002

(54) Materials and methods for biological control of soilborne pathogens

(76) Inventor: Margaret Lydia Smither-Kopperl, Williston, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/767,175

(22) Filed: Jan. 22, 2001

Related U.S. Application Data
(60) Provisional application No. 60/177,477, filed on Jan. 21, 2000.

(51) Int. Cl. C09K 3/00

(52) U.S. Cl. 252/380

(57) ABSTRACT

The subject invention provides materials and methods for the cost-effective control of soilborne pathogens. The plant pathogens, which can be controlled in accordance with the subject invention include fungi, bacteria, nematodes and insects. In a specific embodiment, the composition of the subject invention comprises chitin, produced from crustacean shell waste, and one or more Actinomycetes spp. selected from soil populations for suppressive activity against soilborne pathogens. The actinomycete isolates colonize the chitin and use it as a sole energy source. The combination when applied as a soil amendment suppresses activity of soilborne pathogens.

### CROSS-REFERENCE TO A RELATED APPLICATION

This application claims priority from provisional patent application U.S. Ser. No. 60/177,477, filed Jan. 21, 2000.

### BACKGROUND OF THE INVENTION

It is well known that plant damage can be caused by soilborne phytopathogenic bacteria, fungi, nematodes, insects and other organisms. Soilborne pathogens can harm or destroy the seed or the roots of growing plants. Crop losses of billions of dollars annually are caused by these organisms. Current control methods often rely on soil fumigants. Expenditures in the United States for soil fumigants and nematicides total over $400 million annually.

Methyl bromide fumigation has been the method of choice for soilborne pathogen control for intensive vegetable production in the United States. The use of methyl bromide is very widespread, but other fumigants are also used as fungicides, nematicides and insecticides. These compounds tend to be highly toxic, not only to the target organism but also for humans. Many compounds are being removed from the market for public health and environmental reasons. Methyl bromide, for example, is an ozone-depleting agent and, consequently, under the terms of the Montreal Protocol, its use is being phased out with a complete cessation of use in the United States scheduled by 2005.

Fumigation methods kill soil organisms indiscriminately, including beneficial organisms as well as the soilborne pathogens. Previously fumigated soils can be rapidly recolonized by soilborne pathogens and nematodes. There is an urgent need for alternative products that are effective against a broad range of soilborne pathogens and nematodes with benign environmental effects.

Chitin is a major component of biomass in the soil. Chitin is present in the exoskeleton of arthropods, nematode eggs, protozoa, and mollusca, as well as the walls of most fungi. The addition of chitin amendments to soil usually reduces disease caused by plant pathogenic nematodes and fungi. The N-acetylglucosamine chains are hydrolyzed by chitinases, which are produced by various bacteria, fungi and plants. Chitinases also play a role in disease suppression of soilborne fungi. Chitin amendments to soil have been shown to control phytopathogenic fungi and nematodes (Bell et al., 1998: Mankau, & Das, 1969; Rodriquez-Kabana et al., 1987).

Actinomycete populations in soil increase when chitin is applied. Members of the actinomycetes, including the genus Streptomyces, have been noted in the past to control soilborne fungi. These bacteria have mycelial growth and produce antibiotics. The genetics of Streptomyces has been extensively studied (Hopwood, 1999) with emphasis on the antibiotic production.

There are several products available as soil amendments that are marketed as having the ability to control nematodes or fungi. Each of these products has significant drawbacks, which limit their desirability and or effectiveness, and none claim to control both soilborne fungi and nematodes. Unfortunately, for example, amendments with chitin or with biocontrol agents are not effective on a consistent basis. The currently available products include the following:

ClandoSan® is made from crab and crawfish exoskeletons and is marketed as a natural nematicide by Igene. In 1988, ClandoSan® was registered as by the EPA for use with all agricultural and horticultural crops for control of nematodes. A drawback of this product is its expense and the potential for phytotoxic effects in certain soils at high rates of application. See U.S. Pat. No. 5,057,141.

Mycostop™—Streptomyces griseoviridis (K61) was originally isolated from a Finnish peat bog. This product has had EPA registration since 1994 and is now marketed by AgBio, Inc. for control of soilborne fungi.

Actinovate™—S. lydicus (WYEC 108) was isolated in southern England (Crawford et al., 1993: Yuan and Crawford, 1995) and is marketed by Natural Industries, Inc. to the greenhouse, nursery and turfgrass industries for control of soilborne fungi.

Various soil amendments have also been described in JP 04001109; JP 04209787; JP 06041532; JP 06080531; JP 07002614; JP 09154570; and WO 00/51435.

Alternatives to chemical pesticides and methyl bromide soil fumigation for control of plant diseases and nematodes are urgently needed. An economical and environmentally beneficial broad-based method that acts upon a range of soilborne diseases and nematodes without pesticides is a significant and major contribution. The subject invention provides a unique combination of chitin with one or more biocontrol agents which can be specifically adapted for efficient and cost effective control of particular pests at particular locations.

### BRIEF SUMMARY OF THE INVENTION

The present invention relates to the control of soilborne pathogens which are harmful to plants. The plants which can be protected utilizing the compositions and methods of the subject invention include horticultural and agricultural crops; turfgrasses; and ornamental plants. Transplants as well as container grown plants can be protected according to the subject invention. The pathogens which can be controlled in accordance with the subject invention are chitin-containing pests and include fungi, bacteria, and nematodes. Advantageously, the subject invention provides materials and methods for the cost-effective control of these soilborne pathogens.

In a preferred embodiment, the subject invention provides compositions comprising chitin and a biocontrol agent. The biocontrol agent is able to kill and/or inhibit the growth, development, and/or reproduction of at least one soilborne pathogen. In a specific embodiment, the biocontrol agent is able to colonize chitin and, preferably, utilize chitin as a sole energy source.

In a specific embodiment, the composition of the subject invention comprises chitin, produced from crustacean shell waste, and one or more Streptomyces spp. selected from soil populations for suppressive activity against soilborne pathogens. The Streptomyces isolates colonize the chitin and use it as a sole energy source. The combination when applied as a soil amendment suppresses activity of soilborne pathogens.

### BRIEF SUMMARY OF FIGURES

The file of this patent contains at least one drawing executed in color. Copies of this patent with color drawings(s) will be provided by the Patent and Trademark Office upon request and payment of the necessary fee.

FIG. 1 shows direct isolation of Streptomyces spp. from soil into chitinagar. Note zone of clearing around colonies caused by the secretion of chitinolytic enzymes.

FIG. 2 shows a bioassay for activity of Streptomyces against Fusarium oxysporum f. sp. radicis-lycopersici. Isolate PA16 partially inhibited the fungus, PA98 (A79) sporulated profusely, and completely inhibited the fungus.

FIG. 3 shows growth of isolate PA47 on egg cuticle of Meloidogyne arenaria the root know nematode.

FIG. 4 shows the effect of Fusarium (Fusarium oxysporum f. sp. radicis-lycopersici [FORL] and Streptomyces strain PA98 (A79) on root growth of tomato.

FIG. 5 shows the effect of FORL and Streptomyces strain PA98 (A79) applied as a root dip to 4-week-oldtomato seedlings, planted in Metro-mix and grown in a greenhouse for two weeks.

### DETAILED DISCLOSURE OF THE INVENTION

The subject invention provides materials and methods for the cost-effective control of soilbome pathogens. The pathogens that can be controlled according to the subject invention include fungi such as those in the genera Fusarium, Colletotrichum, Rhizoctonia, Verticillium, Pythium and Phytophthora. Bacterial pathogens, including those that cause wilts such as bacterial wilt (Ralstonia solanacearum), can also be controlled. A further application of the subject invention is for the control of nematode infestations. Damage to plant roots and lower stems caused by insect feeding may also be controlled.

In a preferred embodiment, the subject invention provides compositions comprising chitin and a biocontrol agent. The biocontrol agent is able to kill and/or inhibit the growth, development, and/or reproduction of at least one soilborne pathogen. In a specific embodiment, the biocontrol agent is able to colonize chitin and, preferably, utilize chitin as a sole energy source.

In one embodiment, a biocontrol agent can be used which is able to colonize the rhizosphere of one or more plants of interest. In this context, the biocontrol agent used according to the subject invention can be selected not only for its pesticidal activity and ability to degrade and utilize chitin, but also for its ability to successfully compete and exist in a particular environment taking into account such factors as the plant species to be protected, the soil type, and the other soil inhabitants.

One aspect of the subject invention involves providing biocontrol compositions which are specifically designed and adapted for use in a particular setting. This customization of the product is achieved by, for example, screening soil samples in a particular location in order to identify microbes having the specific characteristics as set forth herein and which thrive in the environment where the composition is to be used.

The biocontrol agents used according to the subject invention include actinomycetes. In a preferred embodiment, the actinomycetes used according to the subject invention are from the family Streptomycetaceae and include microbes from the genera Streptomyces, Streptoverticillium, and Kitasataporia. Organisms in these genera are filamentous shaped bacteria that produce sessile and aerial mycelium in contrast to the more typical rod shaped bacteria as in the genera Agrobacterium; Bacillus; Clostridium; Erwinia; Pseudomonas; and Xanthomonas.

The term “actinomycete” is used hereinto embrace bacteria from the Actinomycetales order. The term “streptomycetes” refers to bacteria from the Streptomyces genus. The genera of Streptomyces, Streptoverticillium and Kitasatospora are embraced within the Actinomycetales order, as set forth in Bergey's Manual, 8th Edition, “Classification of Bacteria”—1974. These genera fall in the Family Streptomycetaceae as outlined in the “Taxonomic Outline of the Archaea and Bacteria”, Bergey's Manual of Systematic Bacteriology, 2nd Edition.

The actinomycete isolates collected from soil populations can be grouped according to several criteria including phenotypic characterization, molecular phylogeny, biological activity or location of isolation.

Phenotypic characterizationcan be used for grouping isolates. The isolates are grown in pure culture on plates containing 1/3 Czapek Dox Yeast extract. The colonies are examined for growth habit and colony. Morphology of substrate and aerial hyphae can be examined using an inverted microscopic. These morphologicalcharacteristics and chemical attributes of the isolates are important for taxonomy of the isolates.

The DNA sequence of 16S DNA is now also used as a taxonomic characteristic (Stackebrandtet al., 1991;1997). Isolates of the subject invention which were subjected to 16S DNA sequencing are all actinomycetes that fall into the family Streptomycetaceae including those from the genera Streptomyces, Streptoverticillium and Kitasatosporia.

Biological activity is the most important criteria governing selection of actinomycetes for use according to the subject invention. Specifically, selection of isolates is made on the basis of chitinase production and antibiotic activity. Genes that confer biological activity include those for chitinase and antibiotics with both antifungal and antibacterial activity.

Actinomycete isolates can be collected from soils at a variety of geographical locations. These different soils each have a microbial community of actinomycete isolates and the isolates are thus selected from a specific ecological community at a specific location. The isolates are thus adapted to the physical and biological environment at their location of isolation.

In a specific embodiment, the composition of the subject invention comprises chitin, produced from crustacean shell waste, and one or more Streptomyces spp. which has suppressive activity against soilborne pathogens including flngi, bacteria and/or nematodes. The actinomycete isolate colonizes the chitin and uses it as an energy source. The combination, when applied as a soil amendment, suppresses activity of soilborne pathogens. Several factors alone and in combination may contribute to the control activity of the compositions of the subject invention. The factors include the generation of ammonium, chitinase, and/or antibiotics; the competitive activity in the rhizospere and the systemic acquired resistance in the plants.

Shrimp and crab waste are particularly preferred sources of chitinous material for the process of the present invention. Other sources of chitinous material include fungi and insects.

Fungal diseases, which can be controlled using the method of the present invention include diseases caused by organisms in the genera Alternaria, Colletotrichum, Fusarium, Helminthosporium, Macrophomina, Phoma, Phytophthora, Pythium, Rhizoctonia, Sclerotium, Thelaviopsis, and Verticillium. Diseases caused by soilborne bacteria including Ralstonia solanacearum (previously Pseudomonas solanacearum), the cause of bacterial wilt, and other members of this genus and other bacteria such as Agrobacterium, Clavibacter, Erwinia. Plant pathogenic nematodes which can be controlled according to the subject invention include those within the orders Tylenchida and Dorylamide.

The subject invention is superior to existing products as it is a combination of chitin and carefully selected actinomycete species. The advantages of this invention over other products include the following:

a. Chitin is added with one or more actinomycete isolates that aids in decomposition of the chitin.

b. Chitin contains high levels of nitrogen, which decomposes to ammonium and nitrate (Smither-Kopperl & Mitchell, 2000) thus producing a fertilization effect.

c. Chitin is a natural product, so its addition to soil is environmentally friendly.

d. The chitin serves as a substrate and energy source for the actinomycetes, allowing the isolates to more effectively compete with native soil microorganisms, and more efficiently colonize the soil.

e. The chitinolytic activity has a suppressive effect on those soilborne pathogens with chitin as a structural component, this includes fungi with chitin in their hyphal walls, nematode eggs, and insect exoskeletons.

f. The actinomycetes can be locally isolated, and thus, adapted to local conditions.

g. The local isolation of the actinomycetes simplifies the regulatory aspects with respect to the importation and movement of exotic or foreign microorganisms

h. The actinomycete isolates which are ubiquitous in soil (typically 106-107 colony forming units/g) can be selected on the basis of antagonism to a variety of soilborne pathogens. This includes but is not limited to the following genera of soilborne fungi, Colletotrichum, Fusarium, Helminthosporium, Macrophomina, Phoma, Phytophthora, Pythium, Rhizoctonia, Sclerotium, Thelaviopsis, and Verticillium; the bacteria Ralstonia and nematode eggs, juveniles and adults of the genera Meloidogyne, Pratylenchus, Xiphenema, Heterodora and Belonolaimus.

i. A combination of selected actinomycetes with antagonism to a variety of different organisms may be added on colonized chitin to target specific disease problems.

j. The selected actinomycete may include those which colonize the plant rhizosphere.

k. The formulation of chitin and colonizing Streptomyces spp. has been tested for shelf life. The combination is robust and has maintained viability for 1 year when dry at room temperature. This is a major advantage as many biocontrol agents have a very limited viability.

l. The compositions of the subject invention are effective at low rates which makes them cost effective.

m. This invention provides growers with an effective, environmentally-friendly and economical product as an alternative to methyl bromide for the control of soilborne pathogens.

### Materials and Methods

Chitin

In the trial described here the chitin used was practical grade chitin from crab shells purchased from Sigma Chemical. Crab and shrimp shells from seafood processors can be used. In a preferred embodiment of the subject invention, the chitin can be processed from crab or shrimp shell waste. There is currently a disposal problem with crab and shrimp shell waste in Florida and other states; it is mainly sent to landfill.

Method of Selection of the Biocontrol Agent(s)

The method of selection of the biocontrol agent(s) is outlined in the following examples.

Following are examples which illustrate procedures for practicing the invention. These examples should not be construed as limiting. All percentages are by weight and all solvent mixture proportions are by volume unless otherwise noted.

### EXAMPLE 1

Isolation of Actinomvcetes from Soil.

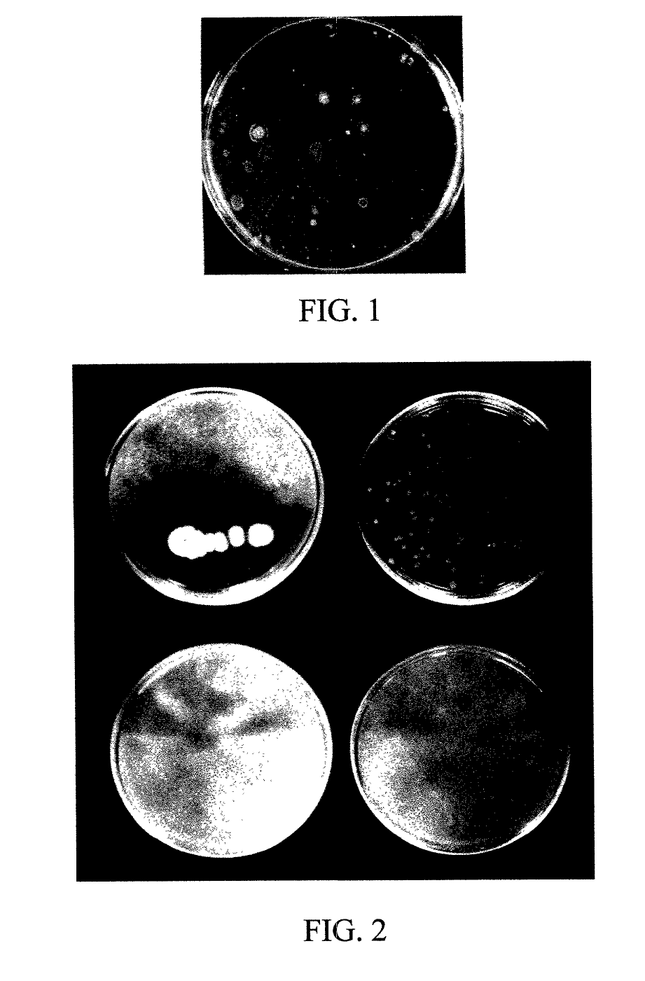

Soil samples were dried and sieved sequentially through 5- and 2-mm mesh screens. Agar media containing 0.4% colloidal chitin was prepared and kept at 50° C. The soil samples were diluted sequentially in sterile water and were mixed with molten agar in Petri plates to give a final dilution concentration of 10-5-10-7. The plates were incubated in darkness. Colonies that developed in the agar were counted after one and two weeks. Clear zones were visible in the colloidal chitin around those isolates that produced exogenous chitinase, and those isolates were chosen selectively for further screening (FIG. 1). Transfers of these isolates are made onto ⅓ CDY agar which is used to grow the isolates for phenotypic characterization.

### EXAMPLE 2

Screening of Actinomycetes for Activity Against Soil-borne Fungi.

Actinomycete isolates were inoculated onto agar media in a line at one side of a 100 mm plate containing a test fungus. The test fungus may be, for example, plant pathogenic isolates of Fusarium oxysporum, Pythium aphanidermatum, P. myriotylum, P. irregulare, Colletotrichum sp. or Rhizoctonia solani. The test fungus was inoculated on the other side of the plate. After coincubation the hyphal length of the fungus from the inoculation point and the zone of inhibition around the actinomycete isolate were measured (FIG. 2). Isolates with high levels of antifungal activity were selected for further trials.

### EXAMPLE 3

Screening of Actinomycetes for Activity against Soil-borne Bacteria.

Actinomycete isolates were inoculated onto the surface of 10% tryptic soy agar containing a suspension of the bacteria Ralstonia solanacearum, the causal agent of bacterial wilt. Isolates with antibacterial activity were selected by the presence of an inhibitory zone around the test actinomycetes. Isolates with activity against R. solanacearum screened to date are from the genus Kitasatospora.

### EXAMPLE 4

Screening of Actinomycetes for Activity against Plant Pathogenic Nematodes.

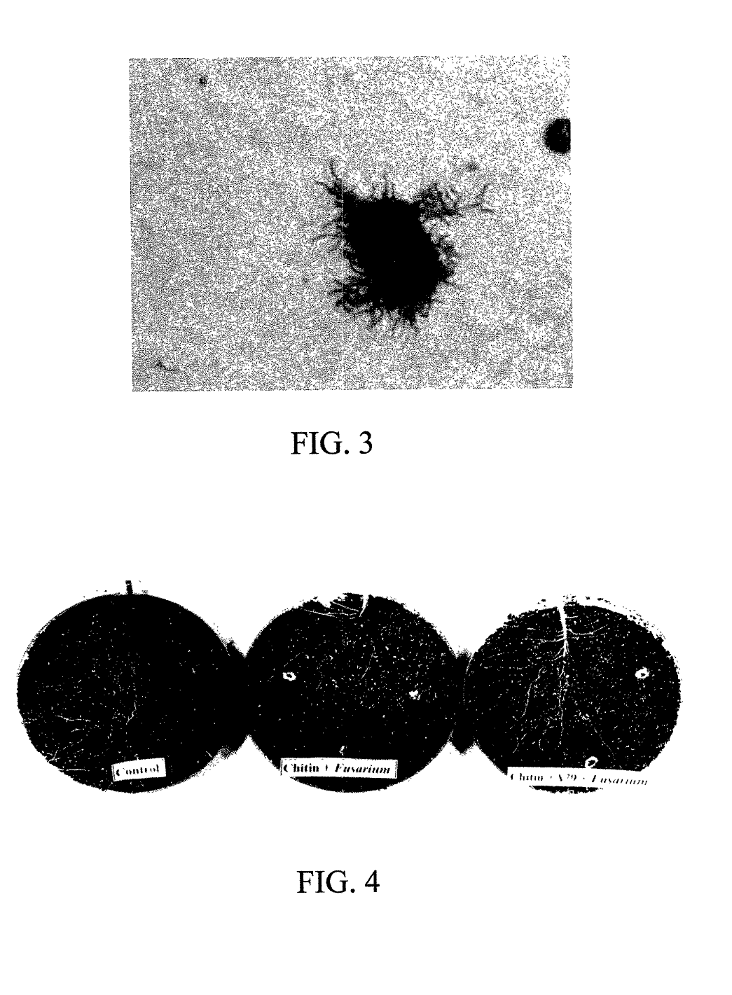

Actinomycete spores were inoculated onto the surface of small Petri plates containing water agar. Sterile nematode eggs were added to the surface of each plate. The plates were incubated and observed for colonization of the eggs by actinomycetes and effect on nematode hatch. Colonization and growth of actinomycete isolates occurred on nematode eggs (FIG. 3). Those isolates that colonized nematode eggs and prevented nematode hatch and survival were selected.

### EXAMPLE 5

Screening of Isolates in vitro for activity against Tomato Seedlings.

This assay determines the effect of the actinomycete isolates on growth of tomato seedlings and whether the isolates colonize the rhizosphere of the seedlings. Actinomycete isolates were inoculated in a line onto water agar 1 cm from the edge of a 10-cm square culture dish and grown for five days. Germinating tomato seedlings with the root radicle just emerging from the seed were placed on the opposite side of the place to the actinomycete with the root pointing towards the actinomycete. The plates were wrapped in foil to exclude light and placed upright with the tomato seed at the top with the root-tip pointing downwards and actinomycete at the bottom. After 48 hours of incubation, the foil was removed and the growth of the tomato seedling examined and compared to the control grown in the absence of actinomycetes. Actinomycetes were selected on the basis of no negative growth to the tomato seedlings. Potential rhizospere colonizers grew and sporulated along the tomato root. Inhibitory isolates caused necrosis of the root tip and negative geotropic effects and these isolates with inhibitory activity were not selected for this invention.

### EXAMPLE 6

Colonization of Chitin and Crustacean Waste by Actinomycete isolates.

Actinomycete spores were added to volumes of chitin, shrimp shells and crab shells that were ground, sterilized and moistened. The mixtures were shaken thoroughly and then left for 4 days to allow the spores to germinate and colonize the chitin. After this time chitin particles were removed and examined for actinomycete growth over the surface. Those isolates with the ability to colonize the chitin, crab and shrimp were selected for use in this invention.

Actinomycete-colonized chitin can be air-dried. Actinomycete spores retained viability upon drying for up to a year when stored at room temperature and germinated when the chitin was moistened.

### EXAMPLE 7

Growth Chamber Trials.

Sterile soil was moistened and placed into 15 cm-Petri plates with one notch cut into the side. A 2-wk-old tomato seedling was placed on the soil of each plate, so that the roots were spread over the soil and the base of the stem placed at the notch, so that the shoot extended outside. Fungus treatments of Fusarium oxysporum were applied as colonized wheat grains adjacent to the root. Treatments were applied by spraying the actinomycete spores onto the roots and soil surface. The plates were sealed with Parafilm® and covered with aluminum foil to exclude light from the roots. The plates with tomatoes were placed at random locations in racks that held them upright in an incubator at 22° C. with 12 hour of light. The tomatoes were fertilized and watered to constant weight every 3 days. After 2 weeks, the plates were opened and the roots examined for symptoms of disease and absence of disease in the presence of the selected isolates (FIG. 4).

### EXAMPLE 8

Greenhouse Trials.

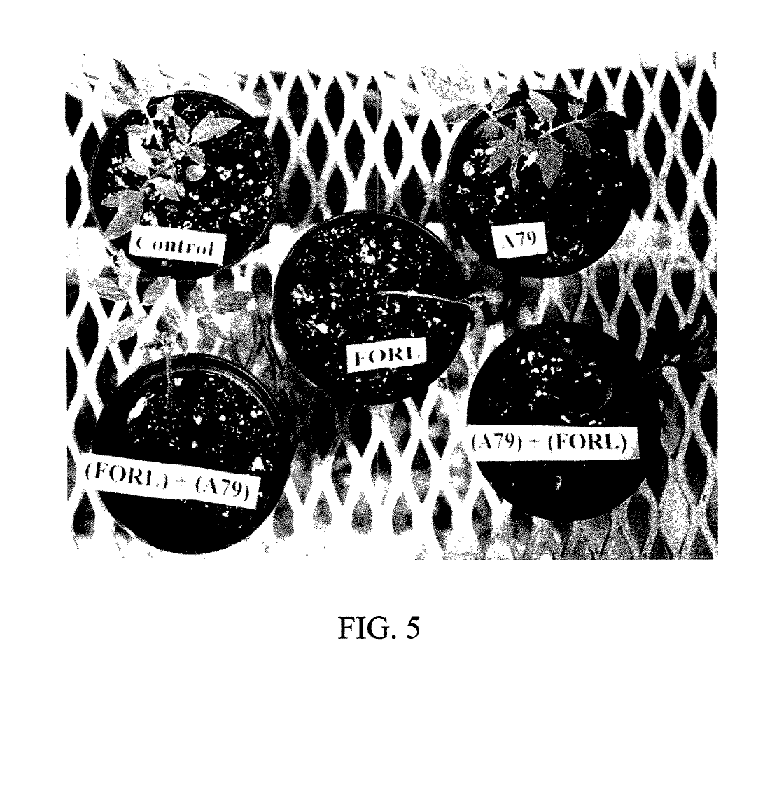

Four-week-old tomato seedlings were treated to root dips of actinomycete isolates and F. oxysporum f.sp. radicis lycopersici spores. The treated seedlings were then planted in microwaved soil in 4 inch pots on a greenhouse bench and the temperature was maintained at 22° C. After 2 weeks the plants were rated for survival and Streptomyces inoculation reduced the incidence of disease (FIG. 5).

### EXAMPLE 9

Identification of Isolates.

Over 300 isolates have been screened as described above. Multiple isolates show potential for commercialization. Descriptions are given of five of the most effective isolates screened and tested to date. The 16S DNA from the isolates has the closest homology with the following:

PA7: Streptomyces nodosus (GenBank Accession Number AF114036), Streptomyces violaceusniger lade (GenBank Accession Number AJ391814)

PA54: Streptomyces paradoxus (GenBank Accession Number AJ276570), Streptomyces nodosus (GenBank Accession Number AF114034),

PA98: Streptomyces echinatus (GenBank Accession Number AJ399465), Streptomyces nodosus (GenBank Accession Number AF 114034),

PA198 Kitasatospora melanogena (GenBank Accession Number U93326), Kitasatospora sp. C2 (GenBank Accession Number AF060792).

TABLE 1
Properties of selected isolates as detected in screening procedure

| | Isolates | | | | |
|---|---|---|---|---|---|
| Properties | PA7 | PA47 | PA54 | PA98 | PA198 |
| Utilization of chitin as a sole energy source | + | + | + | + | + |
| Growth of processed shrimp/crab shell | + | + | + | + | + |
| Profuse sporulation on solid media | + | + | + | + | + |
| Rapid growth in liquid culture | + | + | + | + | + |
| In vitro inhibition of: Fusarium oxysporum | + | − | + | + | w |
| Pythium spp. | + | + | − | + | w |
| Colletotrichum sp. | + | w | w | + | nt |
| Rhizoctonia sp. | + | w | w | w | nt |
| In vitro inhibition of Ralstonia solanacearum | − | − | − | − | nt |
| Colonization of nematode egg cuticle | − | + | + | − | − |
| Inhibition of nematode egg germination | + | + | + | − | + |
| Reduced survival of nematode juveniles | + | + | + | − | + |
| In vitro phytotoxicity to tomato | − | − | − | + | − |
| Colonization of tomato rhizosphere | − | − | + | − | − |
| Phytotoxicity in greenhouse trials | − | − | − | − | − |

+ = Positive response, − = negative response, w = weak response, nt = not yet tested

It should be understood that the examples and embodiments described herein are for illustrative purposes only and that various modifications or changes in light thereof will be suggested to persons skilled in the art and are to be included within the spirit and purview of this application and the scope of the appended claims.

I claim:

1. A composition for the control of soilbome pathogens wherein said composition comprises chitin and a biocontrol agent.

2. The composition, according to claim 1, wherein said biocontrol agent is able to colonize chitin.

3. The composition, according to claim 1, wherein said biocontrol agent utilizes chitin as an energy source.

4. The composition, according to claim 1, wherein said biocontrol agent exhibits chitinase activity.

5. The composition, according to claim 1, wherein said biocontrol agent is an actinomycete.

6. The composition, according to claim 5, wherein said biocontrol agent is a Streptomyces.

7. The composition, according to claim 1, wherein said biocontrol agent is isolated from the location where said composition is to be used.

8. The composition, according to claim 1, wherein said biocontrol agent has one or more activities selected from the group consisting of antifungal, antibacterial, nematicidal, and insecticidal.

9. The composition, according to claim 8, wherein said activity is antifungal.

10. The composition, according to claim 8, wherein said activity is antibacterial.

11. The composition, according to claim 1, wherein said chitin is from crustacean shell waste.

12. The composition, according to claim 11, wherein said crustacean shell waste comprises shrimp or crab shells.

13. The composition, according to claim 1, wherein said biocontrol agent colonizes the plant rhizosphere.

14. The composition, according to claim 1, which comprises additional antifungal, antibacterial, nematicidal and/or insecticidal agents.

15. The composition, according to claim 1, wherein said biocontrol agent is selected from the group consisting of isolates PA7, PA47, PA54, PA98 and PA198.

16. A method for the control of a soilborne pathogen wherein said method comprises administering to said pathogen, or its situs, an effective amount of a composition comprising chitin and a biocontrol agent.

17. The method, according to claim 16, wherein said biocontrol agent is able to colonize chitin.

18. The method, according to claim 16, wherein said biocontrol agent utilizes chitin as an energy source.

19. The method, according to claim 16, wherein said biocontrol agent exhibits chitinase activity.

20. The method, according to claim 16, wherein said biocontrol agent is an actinomycete.

21. The method, according to claim 20, wherein said biocontrol agent is a Streptomyces.

22. The method, according to claim 16, wherein said biocontrol agent is isolated from the location where said composition is to be used.

23. The method, according to claim 16, wherein said biocontrol agent has one or more activities selected from the group consisting of antifungal, antibacterial, nematicidal, and insecticidal.

24. The method, according to claim 23, wherein said activity is antifungal.

25. The method, according to claim 23, wherein said activity is antibacterial.

26. The method, according to claim 16, wherein said chitin is from crustacean shell waste.

27. The method, according to claim 26, wherein said crustacean shell waste comprises shrimp or crab shells.

28. The method, according to claim 16, wherein said biocontrol agent colonizes the plant rhizosphere.

29. The method, according to claim 16, which comprises additional antifungal, antibacterial, nematicidal and/or insecticidal agents.

30. The method, according to claim 16, wherein said biocontrol agent is selected from the group consisting of isolates PA7, PA47, PA54, PA98 and PA198.

31. A method for preparing a composition for the control of soilborne pathogens wherein said method comprises combining chitin with a biocontrol agent.

32. The method, according to claim 31, wherein said biocontrol agent is a streptomyces which exhibits chitinase activity and which has one or more activities selected from the group consisting of antifungal, antibacterial, nematicidal, and insecticidal.

33. The method, according to claim 31, wherein said chitin is from crustacean shell waste.
